(19) United States
(12) Patent Application Publication
(10) Pub. No.: US 2014/0106164 A1
(43) Pub. Date: Apr. 17, 2014

(54) RADIATIVE SURFACE

(71) Applicants: UNIVERSITE DE CERGY-PONTOISE, Cergy (FR); THALES, Neuilly-sur-Seine (FR)

(72) Inventors: Jean-Paul DUDON, Le Val (FR); Evelyne CHASTAING, Palaiseau (FR); Frederic VIDAL, Maurecourt (FR); Isabelle FABRE-FRANCKE, Nanterre (FR); Pierre-Henri AUBERT, Osny (FR); Claude CHEVROT, Saint Germain en Laye (FR); Anne Sandra TEISSIER, Annecy (FR)

(21) Appl. No.: 14/052,540

(22) Filed: Oct. 11, 2013

(30) Foreign Application Priority Data
Oct. 12, 2012 (FR) 12 02725

(51) Int. Cl. B64C 1/38

(52) U.S. Cl. CPC B64C 1/38
USPC 428/336; 428/463; 428/419; 427/250

(57) ABSTRACT

A radiative surface comprises a film comprising: a semi-interpenetrated or interpenetrated network of a first ion-conducting polymer and of a second electron- and electrochrome-conducting polymer; and an electrolyte for impregnating the network; the film comprising a first face intended to be in contact with the solar radiations, the first face being covered with a first metallic layer in order to reduce the absorptivity of the solar radiations. A method for creating the radiative surface is also provided.

### CROSS-REFERENCE TO RELATED APPLICATION

This application claims priority to foreign French patent application No. FR 1202725, filed on Oct. 12, 2012, the disclosure of which is incorporated by reference in its entirety.

### FIELD OF THE INVENTION

The invention relates to the active heat control of spacecraft and more particularly a radiative surface for spacecraft. Also, more specifically, the invention relates to a device with variable emissivity suitable for use as radiative surface for spacecraft.

### BACKGROUND

The aim of heat control is essentially to guarantee that the temperature of the component parts of a spacecraft is maintained within a range of temperatures compatible with their specifications. It involves, notably, avoiding exceeding temperatures above which a material of the spacecraft would be damaged or destroyed, but also, remaining within a range of temperatures that makes it possible to guarantee a predetermined life span for an electronic component.

There are two management modes for the heat exchanges on board spacecraft: a so-called passive mode and a so-called active mode.

The principle of passive management of heat exchanges is based on the Stefan-Boltzmann law according to which the total power radiated per unit surface area involves the temperature, of the bodies present, to the fourth power, but also the thermo-optical properties of the exchange surfaces such as the emissivity ε and absorptivity α.

The emissivity ε of a material is an abstract number between 0 and 1, denoting the capacity of a material to emit heat by radiation.

The absorptivity α of a material denotes the capacity of a material to convert an electromagnetic energy into another energy.

Thus, the passive heat management of the heat exchanges uses materials, coatings or surface treatments that make it possible to obtain properties. Conventionally, the surfaces intended to cool equipment items are covered with small mirrors made up of thin sheets of silver-plated silica. A surface is thus obtained that has a high emissivity factor, in other words, a good capacity to emit heat towards space and a low absorptivity factor, in other words, a good capacity to reflect the solar radiations.

One drawback with this type of application is that they are not modulable and do not make it possible to adapt to changes of environment, a change of orientation of the satellite relative to the solar radiation for example.

An active management of the heat exchanges notably uses reheaters such as thermal resistors. The thermal resistors generally take the form of strips or sheets, generally glued onto the surfaces that are to be reheated. These resistors are controlled by a thermostat which switches them on as soon as the temperature holds below a previously set temperature. The devices of thermal resistor type require energy. Now, in the context of applications for spacecraft, it is necessary to minimize the quantities of energy installed on board these craft.

For several years now, there have been innovative coating devices with variable emissivity being developed. In a cold environment, the emissivity is minimal so as to retain the heat generated by the embedded equipment items whereas, in a hot environment, the emissivity is maximal so as to discharge the heat energy outwards.

Inorganic materials of Bragg array type have been used, a Bragg array being a high quality reflector. It is a structure in which there is an alternation of layers of materials with different refractive indices, which results in a periodic variation of the effective refractive index. At the boundary between two layers, a partial reflection of the waves occurs. For waves with a wavelength approximately equal to four times the optical thickness of a layer, the reflections are combined by constructive interferences and the layers act as a mirror.

Creating this type of material entails applying high temperatures, incompatible with flexible polymer substrates used for radiative surfaces.

A second innovation consists in covering the surfaces of polymers sensitive to high temperatures with patches forming a multilayer device, this multilayer concept being able to comprise up to five or seven patches, only one of the patches having variable emissivity. According to this technology, an electrolyte is introduced between the polymer surface and the reflecting patch in order to allow for the electrochromism phenomenon.

One drawback with this technology is the risk of leakage of the electrolyte and the degradation of the polymer material.

### SUMMARY OF THE INVENTION

One aim of the invention is to create a device with variable emissivity that is capable of overcoming the implementation problems described previously.

According to the invention, a radiative surface is proposed comprising:
a film comprising:
   a semi-interpenetrated or interpenetrated network of a first ion-conducting polymer and of a second electron- and electrochrome-conducting polymer;
   an electrolyte for impregnating said network,
said film comprising a first face intended to be in contact with the solar radiations, said first face being covered with a first metallic layer in order to reduce the absorptivity of the solar radiations.

Advantageously, the first metallic layer has a thickness of between approximately a few nanometres and a few tens of nanometres.

In this particular case, the term “ion-conducting polymer” designates a polymer possibly comprising so-called polar groupings notably comprising —OH, —COOH, —CH₂—CH₂—O—, NH₂, functions, favouring the ion displacement. For example, an ethylene glycol grouping is capable of chelating a cation weakening the ion interaction between the anion and the cation and favouring the displacements of the anions from one chelated cation to another.

The group of ion-conducting polymers comprises, notably, the family of polyalkyl oxides and the family of polyacrylates and polymethacrylates as well as the family of jeffamines.

The term “electron-conducting polymer” denotes a polymer possibly comprising a chain of sp²-hybridized carbons with sp³-hybridized carbons forming a conjugated system in which the electrons are relocated.

The group of electron- and electrochrome-conducting polymers notably comprises the family of polythiophenes, the family of polyanilines, the family of polypyrroles, the family of polyparaphenylene.

The term “polymer network” denotes one or more cross-linked polymers whose chains are bonded together by covalent links.

The terms “interpenetrated network<<or RIP represent an assembly of at least two polymers cross-linked one inside the other thus forming one or more networks.

The term “semi-interpenetrated network” or s-RIP represents an assembly comprising at least one cross-linked polymer forming a network and at least one non-cross-linked polymer, tangled in the first network and not forming a second network.

The terms “soak up” or “inflate” will be used interchangeably. A polymer network, an interpenetrated or semi-interpenetrated polymer network brought together with an electrolyte does not dissolve, the solvent of the electrolyte being incapable of breaking the bonds allowing for dissolution. The electrolyte then penetrates into the material resulting in a mechanical inflation of the latter which is saturated with electrolyte.

In the embodiment proposed by the invention, the electrodes are directly incorporated in a material, which makes it easier to implement the radiative surface comprising said material and allows for a better flow of the electrostatic charges originating from the plasma surrounding the satellite.

This type of technology allows for a better heat control while consuming less electrical energy and consequently less installed weight due to the batteries.

The first ion-conducting polymer comprises polyoxyethylene or POE and the second electron- and electrochrome-conducting polymer comprises poly(3,4-ethylenedioxythiophene) or PEDOT.

The choice of the semi-interpenetrated network comprising POE and PEDOT or POE/PEDOT s-RIP allows for an electrochrome switching of the radiative surface as a function of the state of oxidation of the PEDOT. Furthermore, PEDOT is a polymer that is known to have a good stability during oxido-reduction cycles and a high reflectivity variation amplitude between its oxidized state and its reduced state.

The s-RIP also comprises at least one first metallic layer CM1 on a first face in contact with the solar radiations.

Advantageously, the first layer CM1 comprises gold, silver or aluminium.

Advantageously, the first layer comprising gold has a thickness of between a few nanometres and a few tens of nanometres, and preferentially between 2.5 nm and 21 nm.

The addition of the first metallic layer on the face of the radiative surface in contact with the solar radiations makes it possible to reduce the absorptivity α which makes it possible to protect notably the s-RIP from the solar radiations.

The interpenetrated network also comprises at least one second metallic layer on its second face.

Advantageously, the second metallic layer comprises gold, silver or aluminium.

Advantageously, the second layer comprising gold has a thickness of a few tens of nanometres, and preferentially between 27 and 50 nm.

The addition of the second metallic layer makes it possible to increase the surface conductivity of the POE/PEDOT s-RIP thus facilitating the powering up of the radiative surface.

The electrolyte is an ion liquid, advantageously (1-ethyl-3-methylimidazolium bis(trifluoromethanesulfonyl)imide) or EMITFSI.

According to another aspect of the invention, a method for creating a radiative surface as described previously is proposed.

It comprises the following steps:
the creation of a semi-interpenetrated or interpenetrated network comprising:
   a first ion-conducting polymer network and
   a second electron- and electrochrome-conducting polymer or polymer network,
the creation, by thermal evaporation, of the first metallic layer on the face of the network in contact with the solar radiation,
the impregnation of the network by the electrolyte.

The method also comprises a step of creating a second metallic layer on the second face of the radiative surface.

The ion liquids are salts with a melting point below 100° C., even below 0° C., and with a vapour pressure that is very low, even non-measurable, which is a significant advantage for space applications.

### BRIEF DESCRIPTION OF THE DRAWINGS

The invention will be better understood on studying a few embodiments described as nonlimiting examples, and illustrated by appended drawings in which:

FIG. 1 represents the steps of formation of an interpenetrated network and of a semi-interpenetrated network, according to one aspect of the invention,

FIG. 2 schematically represents the different steps of synthesizing a semi-interpenetrated network comprising POE and PEDOT, according to one aspect of the invention,

FIG. 3 represents a rack for deposition by thermal evaporation used for the creation of the first and second layers of gold on the faces of the POE/PEDOT s-RIP, according to one aspect of the invention,

FIG. 4 is a diagram representing the variations of reflectivity as a function of the thickness of the layer of gold deposited on a POE/PEDOT s-RIP, according to one aspect of the invention, and

FIGS. 5a and 5b are diagrams representing the reflectivity variations of a POE/PEDOT s-RIP covered with a layer comprising gold with a thickness of 6 nm and a POE/PEDOT s-RIP covered with a layer comprising gold with a thickness of 27 nm, as a function of the state of oxidation of the PEDOT, according to one aspect of the invention.

### DETAILED DESCRIPTION

FIG. 1 represents the steps of formation of an interpenetrated network and of a semi-interpenetrated network. FIG. 1a represents a homogeneous mixture in solution of monomers comprising a monomer 1 and a monomer 2. FIG. 1b represents a first three-dimensional network R1 of a polymer comprising monomers 1, the three-dimensional polymer network R1 being inflated with a solution comprising the other monomers 2. FIG. 1c represents the first network R1 and a second polymer network R2 comprising the monomers 2. The first network R1 and the second network R2 are tangled together to form an interpenetrated network or RIP.

It is possible to produce an interpenetrated network sequentially in two steps: a first step of formation of a first network and a second step of formation of the second network. Alternatively, it is possible to produce an interpenetrated network in a single step of formation of the first and second network.

FIG. 1d represents a semi-interpenetrated network s-RIP comprising a first polymer network R1 comprising monomers 1 and a polymer comprising the monomers 2, the polymer comprising the monomer 2 not being in the form of a network.

This type of RIP or s-RIP structure allows for a stable mixing of polymers in which a synergy of the properties of the polymers can be observed.

The polymerization of the monomers can be chemical or electrochemical.

The polymerizations of the monomers 1, 2 can be produced sequentially or simultaneously.

The creation of a radiative surface comprising an electrochrome device covered on at least one of its faces with a metallic layer can comprise two steps: a first step of creation of the electrochrome device and a second step of production of the metallic layers.

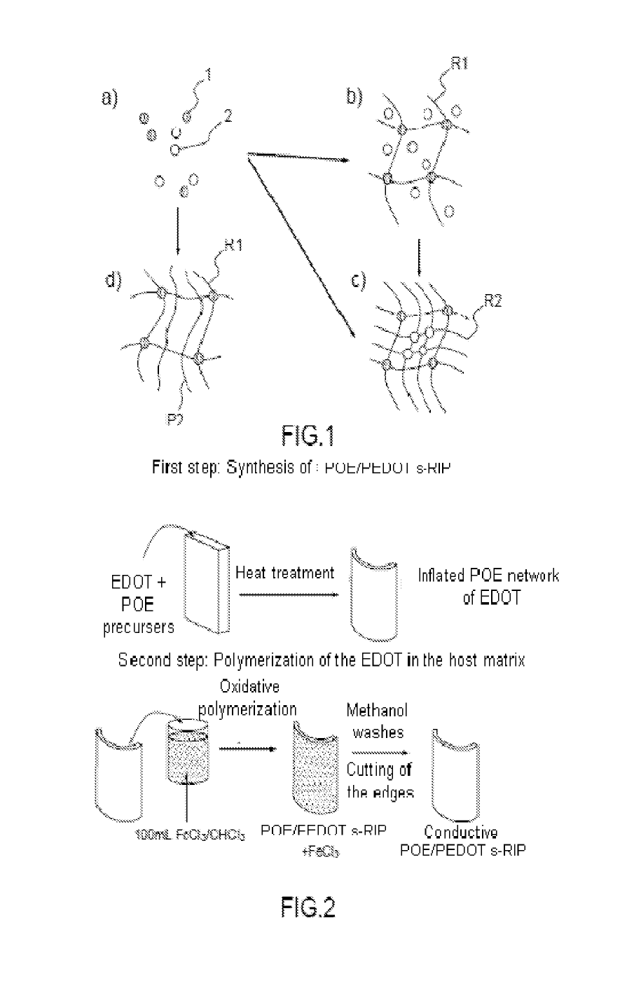

FIG. 2 represents the first step of creation of the radiative surface according to one aspect of the invention. It schematically illustrates the main steps in the creation of a semi-interpenetrated network s-RIP comprising POE and PEDOT, POE/PEDOT s-RIP. This synthesis is described in the international patent application WO 2010/058108.

The synthesis of thin films of conductive s-RIPs exhibiting electro-emissivity properties is performed in two main steps.

The first step in the synthesis consists in creating a network of poly(oxyethylene) POE containing the monomer 3,4-ethylenedioxythiophene EDOT used as solvent and which, by polymerization, will lead to the poly(3,4-ethylenedioxythiophene) PEDOT.

The matrix, in this case POE, is made up of a three-dimensional network containing pendant chains, a pendant chain being a polymer chain bonded to the polymer network by a single link. These chains give the material a plasticizing effect. Following measurements of ion conductivity, the precursor mixture for the formation of the POE matrix has been optimized. A mixture comprising poly(ethylene glycol) methacrylate methyl ether) PEGM and (poly(ethylene glycol) dimethacrylate) PEGDM makes it possible to obtain a good trade-off between the properties of ion conductivity and the mechanical properties of the matrix.

The mixture of the precursors also comprises a primer, 2,2′-azobis-isobutyronitrile AIBN, whose weight represents 1% of the total weight of monomers that make up the POE matrix.

The mixture is then introduced, using a syringe, between two glass plates separated by a PTFE seal, the thickness of the PTFE seal making it possible to vary the thickness of the POE/PEDOT s-RIP material.

The mixture comprising the precursors of the POE, of the EDOT and of the primer undergoes a heat treatment at a temperature of 50° C. After thermal decomposition of the primer, the methacrylate functions of the PEGDM and of the PEGM are copolymerized, leading to the formation of the network in the form of a film.

The solution making it possible to create the POE comprises 2% EDOT by weight. The POE film thus formed is inflated with EDOT monomer.

The second step in the preparation of POE/PEDOT s-RIPs consists in forming the electron- and electrochrome-conducting polymer, in this case the PEDOT. The POE networks containing 2% EDOT by weight are immersed in an oxidizing solution of chloroform containing anhydrous iron chloride FeCl₃ in a concentration of 0.25 mol·L⁻¹. The polymerization is performed at a temperature of between 30 and 50° C. for a duration of between 30 minutes and 2 hours. At the end of this polymerization, the materials are immersed in succession in a number of methanol baths in order to remove the excess FeCI₃ and EDOT that has not been polymerized.

The organic electrochrome devices based on semi-interpenetrated polymer networks exhibit performance levels that are highly promising for the modulation of the heat exchanges in the infrared and the visible ranges through emissivity control. They can be used directly as device with variable emissivity. However, two major lines of advance seem to have been identified for a radiative surface application installed on a spacecraft.

Alternatively, the ion-conducting polymer can be cellulose derivatives, derivatives of alkyl polymethacrylates or nitrile butadiene derivatives, for example.

Alternatively, the electron- and electrochrome-conducting polymer can be derivatives of polyanilene or poly(3,4-propylenedioxythiophene), for example.

Alternatively, the electrochrome device can comprise an interpenetrated network comprising a conductive polymer such as derivatives of polythiophene or derivatives of polypyrrole, for example, these polymers being able to be cross-linked.

On the one hand, it is necessary to reduce their absorptivity α without degrading the contrast in emissivity in the infrared band.

On the other hand, it is necessary to increase the electrical surface conductivity of the device in order to facilitate the powering up of these devices.

It is proposed to deposit a first metallic layer on the surface in direct contact with the solar radiations. Advantageously, the metallic layer comprises gold, silver or aluminium.

In this particular case, the first metallic layer is deposited by a vacuum evaporation technique. Other vacuum deposition techniques can be used, notably cathodic sputtering. The thermal evaporation technique consists in heating a material by the Joule effect in a strong vacuum, and when vaporized, the material will be deposited on the samples to be covered.

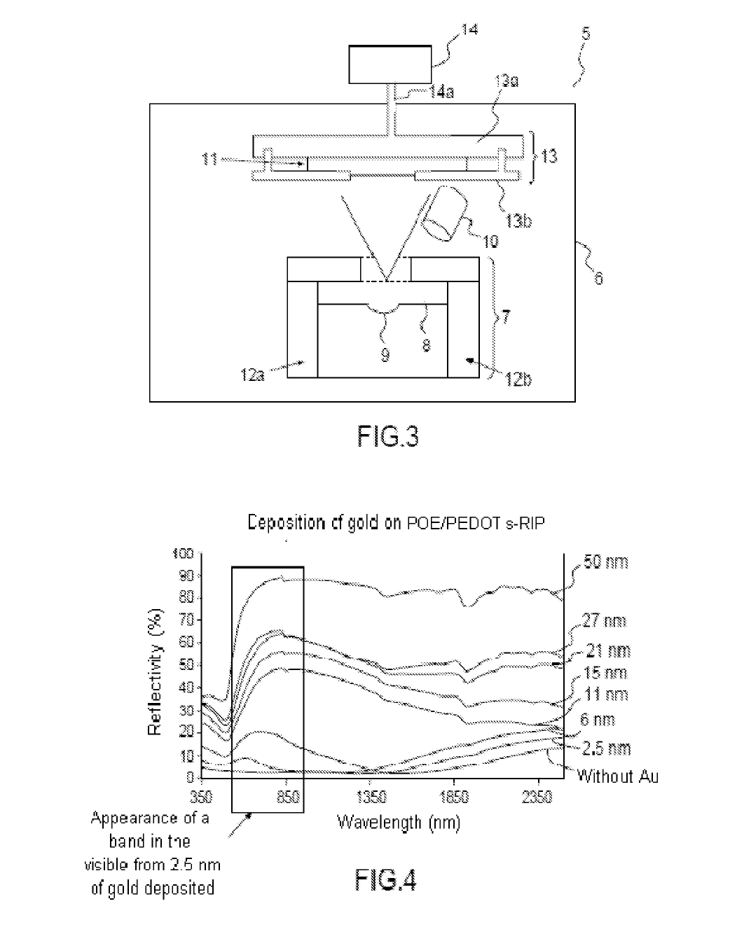

FIG. 3 represents a rack for metallic deposition in a vacuum by thermal evaporation, of “Edwards Auto 306” (registered trade mark) type.

The deposition rack is associated with a vacuum pump, not represented in FIG. 3, the deposition chamber 6 being able to reach pressures of the order of 10⁻⁶ to 10⁻⁷ Torrs, all the parts of the rack comprising titanium or tungsten.

The deposition rack comprises a source 7 comprising a filament 8, the filament 8 being generally in the form of a flat strip which comprises a crucible-shaped deformation 9 that can serve as receptacle for depositing the metal therein, in the form of sticks, to be evaporated. Usually, the filament 8 comprises tungsten, the melting point of this material being greater than the evaporation point of the materials to be deposited by thermal evaporation.

In order to control the thickness of the deposited metallic layers, a quartz microbalance 10 is used. The principle of the latter consists in detecting the drift of the quartz oscillation frequency by the modification of its weight during the growth of the deposited layer, the quartz being positioned as close as possible to the samples 11 so that the deposition is also performed on the quartz. The measurement of the weight of metal deposited is consequently an electrical measurement that must obviously be calibrated according to the position of the quartz microbalance in relation to the samples. Each time an experiment is started, the reference frequency is redefined. By measuring the frequency shift as a function of time, it is also possible to determine the rate of growth of the deposited metallic layers.

The tungsten filament 8 is connected to two electrodes 12a, 12b, between which is applied a potential difference ddE that makes it possible to heat up the filament 8. The metal to be deposited, in this case gold in the form of sticks, is introduced into the crucible 9 consisting of the filament 8.

The POE/PEDOT s-RIP is inserted into a sample-holder 13 which comprises a support 13a comprising aluminium and a cover comprising copper. The cover 13b is dimensioned in such a way as to obtain a final square material with 3 cm sides. The sample-holder 13 is fixed to a support, the support being fixed to a shaft 14a associated with a motor 14 making it possible to rotate the samples during the deposition, making it possible to deposit metallic layers of uniform thickness.

The gold depositions are performed with very precise conditions: of pressure, of rotation speed and of deposition time, and upon which depends the thickness of the deposited layers of gold.

Once the samples 11, in this case the POE/PEDOT s-RIPs, have been introduced into the chamber 6, the pressure of the chamber 6 is lowered to values of the order of 8.10⁻⁷ Torrs.

A potential difference ddE is applied between the two electrodes 12a, 12b. This potential difference ddE corresponds to current intensities of the order of 24 to 28 A.

The tungsten filament 8 is heated. Initially, the sticks of gold are melted then evaporated. During the evaporation, the pressure inside the chamber rises to approximately 2.10⁻⁶ Torrs. The temperature of the samples 11 remains substantially constant, of the order of 25 to 26° C., which avoids damaging the POE/PEDOT s-RIPs.

In these experimental conditions, the rate of deposition is between 0.11 and 0.19 nm·s⁻¹.

The metallization time by thermal evaporation is between 30 seconds and 5 minutes depending on the desired thickness of the layer of gold.

Other metallic layers can be superposed in order to limit the destructive effects linked to other types of radiations, notably X or gamma radiations.

A cooling time of the order of 15 minutes is observed before raising the pressure back up inside the chamber 6 of the rack and removing the samples.

FIG. 4 represents a diagram of reflectivity as a function of the wavelength for different thicknesses of gold deposited on a POE/PEDOT s-RIP 11.

The measurements of reflectivity of a layer of gold with a thickness of between 0 and 50 nm on a POE/PEDOT s-RIP show that the reflectivity increases with the thickness of the layers of gold over the entire visible and infrared range.

In the visible range, between 400 and 700 nm, an increase in reflectivity is observed with a deposition of gold on a POE/PEDOT s-RIP. The increase in reflectivity in the visible range appears as soon as a layer comprising gold 2.5 nm thick is deposited. In fact, in the absence of any layer deposition comprising gold, the reflectivity is between 2 to 3%. When a layer of gold 2.5 nm thick is deposited on a POE/PEDOT semi-RIP, the reflectivity reaches close to 10%. When a layer comprising gold 50 nm thick is deposited, the reflectivity is of the order of 90%.

In the infrared range, between 780 and 2500 nm, the reflectivity increases in the same way with the increase in the thickness of the layer of gold deposited on the semi-RIPs.

These results show that it is possible to reduce the absorptivity α.

Numerous tests have made it possible to optimize the thickness of the first metallic layer in contact with the solar radiations so as to minimize the absorptivity factor α of the device while limiting the impact on the emissivity of the electrochrome device.

Advantageously, a layer comprising gold with a thickness of between 2.5 and 21 nm makes it possible to obtain the best trade-off between absorptivity and emissivity.

Moreover, other tests have shown that a metallic layer comprising gold or silver or aluminium on the face which is not directly in contact with the solar radiations makes it possible to increase the surface conductivity of the POE/PEDOT s-RIP electrochrome device thus allowing for a better electrical contact of the electrochrome device which facilitates the powering up of the device.

Numerous measurements have made it possible to optimize the thickness of the layer. Preferentially, a layer comprising gold with a thickness of between 27 and 50 nm makes it possible to obtain a good electrical contact.

The POE/PEDOT s-RIPs 11 that are metallized on both faces are then inflated with ion liquid serving as electrolyte.

The inflation takes place over 3 days by pressing the POE/PEDOT/Au s-RIP between Petri dishes topped by a weight. The rate of inflation of the POE/PEDOT/Au s-RIPs varies according to the thickness of the metallic layers. Thus, the highest rate of inflation is obtained for a POE/PEDOT s-RIP covered with layers comprising gold with a thickness of 6 nm for the first layer and of 27 nm for the second layer comprising gold.

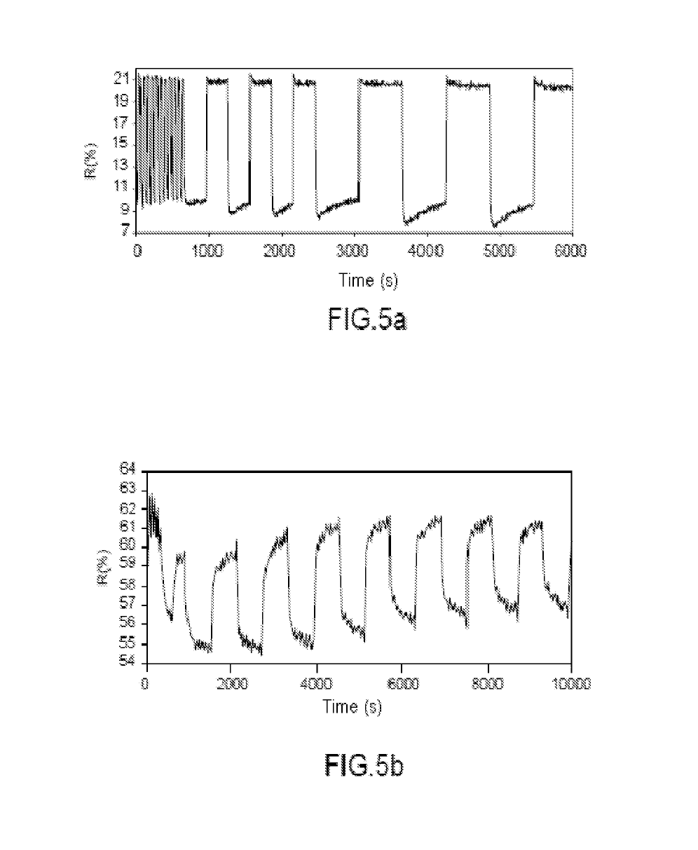

FIGS. 5a and 5b represent the spectra characterizing the optical performance levels of the POE/PEDOT/Au devices inflated with EMITFSI.

The optical performance levels of the POE/PEDOT/Au devices inflated with EMITFSI are evaluated in FIG. 5a during their changes of oxido-reduction state. This change is obtained by electrochemical switching between the reduced state in which the material is absorbent in the infrared range and the oxidized state in which the material is reflective in the infrared.

The potentials applied are +/−1.2 V for periods of time varying from 30 seconds to 10 minutes.

FIG. 5a shows that a radiative surface comprising a POE/PEDOT s-RIP whose face in contact with the solar radiations is covered with a 6 nm metallic layer and inflated with EMITFSI exhibits a maximum reflectivity at 2500 nm of 21% in the oxidized state and a minimum reflectivity at 2500 nm of 8 to 9% in the reduced state. This type of device allows for a reflectivity variability of approximately 10%. Moreover, the switching time from the reduced state to the oxidized state observed for these raw materials is approximately 30 seconds.

FIG. 5b shows that a radiative surface comprising a POE/PEDOT s-RIP whose face in contact with the solar radiations is covered with a 27 nm metallic layer and inflated with EMITFSI exhibits a maximum reflectivity at 2500 nm of 60% in the oxidized state and a minimum reflectivity at 2500 nm of 55 to 57% in the reduced state. This type of device allows for a reflectivity variability of approximately 3 to 5%. FIG. 5b clearly shows that the increase in the thickness of the layer comprising gold reduces the absorptivity of the solar radiations but to the detriment of the amplitude of the variation of the emissivity.

FIGS. 5a and 5b also show that a metallic layer on the surface directly in contact with the solar radiations does not prevent the switching of the POE/PEDOT s-RIP.

1. A radiative surface comprising:
a film comprising:
a semi-interpenetrated or interpenetrated network of a first ion-conducting polymer and of a second electron- and electrochrome-conducting polymer;
an electrolyte for impregnating said network,
said film further comprising a first face intended to be in contact with the solar radiations, said first face being covered with a first metallic layer in order to reduce the absorptivity of the solar radiations.

2. The radiative surface according to claim 1, in which the first metallic layer has a thickness of between approximately a few nanometres and a few tens of nanometres.

3. The radiative surface according to claim 1, in which the first ion-conducting polymer comprises polyoxyethylene (POE).

4. The radiative surface according to claim 1, in which the second electron- and electrochrome-conducting polymer comprises poly(3,4-ethylenedioxythiophene) (PEDOT).

5. The radiative surface according to claim 1, in which the first metallic layer comprises gold, silver or aluminium.

6. The radiative surface according to claim 5, in which the first layer comprising gold has a thickness of between 2.5 and 21 nm.

7. The radiative surface according to claim 1, in which the semi-interpenetrated or interpenetrated network also comprises at least one second metallic layer on its second face.

8. The radiative surface according to claim 7, in which the second metallic layer comprises gold, silver or aluminium.

9. The radiative surface according to claim 8, in which the second layer comprising gold has a thickness of between 27 and 50 nm.

10. The radiative surface according to claim 1, in which the electrolyte is an ion liquid.

11. The radiative surface according to claim 10, in which the electrolyte is (1-ethyl-3-methylimidazolium bis(trifluoromethanesulfonyl)imide) or EMITFSI.

12. A method for creating a radiative surface according to claim 1, comprising the following steps:
creating a semi-interpenetrated or interpenetrated network comprising:
a first ion-conducting polymer network and
a second electron- and electrochrome-conducting polymer or polymer network,
creating, by thermal evaporation, the first metallic layer on the face of the network in contact with the solar radiation,
impregnating the network by the electrolyte.

13. The method according to claim 12, further comprising creating a second metallic layer on the second face of the radiative surface.
